(19) United States
(12) Patent Application Publication
(10) Pub. No.: US 2002/0175307 A1
(43) Pub. Date: Nov. 28, 2002

(54) Drive for a butterfly damper with double acting over center lock

(76) Inventors: Francis J. McCabe, Ottville, PA (US); Paul B. Keenan, Quakertown, PA (US)

Correspondence Address: BENASUTTI, P.A., 17294 BERMUDA VILLAGE DRIVE, BOCA RATON, FL, 33487, US

(21) Appl. No.: 10/015,312

(22) Filed: Dec. 11, 2001

Related U.S. Application Data
(60) Provisional application No. 60/293,656, filed on May 25, 2001.

(51) Int. Cl. F16K 1/16

(52) U.S. Cl. 251/302; 251/279

(57) ABSTRACT

A butterfly damper has a plurality of blades movable between an open and a closed position in response to an operating means attached to the blades and attached to an actuating means. A shaft rotatable about its axis in response to said actuating means has crank arm means attached to it and to said blades, to open and close said damper in response to rotation of said shaft. Connector arm means are pivotally connected to crank arms and pivotally connected to said blades at pivot point locations such that the pivot points of said pivotal connections are over center of the plane of the axis of said shaft when the blades are in the closed position.

### CROSS REFERENCE TO RELATED APPLICATIONS

This application is a continuation-in-part of our prior co-pending application for a CHAIN OPERATOR DRIVE FOR A BUTTERFLY DAMPER WITH DOUBLE ACTING OVER CENTER LOCK, application Ser. No. 60/293,656, filed May 25, 2001, and incorporates the disclosure of that application herein as if fully set forth.

### BACKGROUND OF THE INVENTION

1. Technical Field

This invention relates to fire/smoke butterfly dampers and, in particular, to a mechanism for operating and locking said dampers in open and closed positions.

2. Background Art

In the prior art, a variety of means are known for actuating dampers to move the blades from a closed to an open position and to return them to the closed position. In the prior art, it is also known to mount ceiling dampers in fire rated ceilings. The fire rating requires a maximum setback for the damper of 3 inches. Accordingly, the blades open backwardly out of the direction of the room and back into the duct through which air is flowing into the room.

In the event of a fire, it is desirable to fully close the blades and have the remain closed. However, it is also anticipated that a fireman may come into the room and point his fire hose in the direction of the damper, thereby blowing the blades back and open. For an underwriter's listing, the damper must function so that the blades do not blow open.

One way noted in the prior art for preventing this from happening is to have environmental clips, that is, clips which prevent the opening of the blades in response to the heat generated by the fire. Since the underwriters expose the damper for a period of time of approximately an hour, they would also expose the bi-metal clips of our prior art products to the same temperatures. As a result, the clips expand within the damper frame and prevent the blades from being forced back, that is, the damper will not open.

Without these clips, the damper would have to rely on its actuator mechanism to prevent opening.

### DISCLOSURE OF THE INVENTION

Summary of the Invention

The present invention involves the use of the operator means of a damper mechanism to hold the damper shut. The mechanism uses pivot points in the operator means which are over center, providing for a double acting over center lock.

In the preferred embodiment, our invention comprises a butterfly damper having a plurality of blades movable between an open and a closed position in response to an operating means attached to the blades and attached to an actuating means, said damper operating means having a shaft rotatable about its axis in response to said actuating means; and crank arm means attached to said shaft and said blades, to open and close said damper in response to rotation of said shaft; said crank arm means further comprising crank arms connected to said shaft and connector arm means pivotally connected to said crank arms and pivotally connected to said blades at pivot point locations such that the pivot points of said pivotal connections are over center of the plane of the axis of said shaft when the blades are in the closed position.

In the damper the pivot point connection locations are such that the pivot points of said pivotal connections are over center of the plain of the axis of said shaft when the blades are in the open position.

Each crank arm has a distal end remote from the crank arm's connection to said shaft and brackets are mounted to said distal ends; and U-shaped brackets are attached to said distal ends; and the connector arm means are connected to said brackets.

### BRIEF DESCRIPTION OF DRAWINGS

FIG. 1 is a side perspective view of a damper in accordance with our invention shown in the closed position;

FIG. 2 is side perspective view partially broken away of the damper shown in FIG. 1; except that it is in the open position;

FIG. 3 is a top view of the damper shown in FIG. 2;

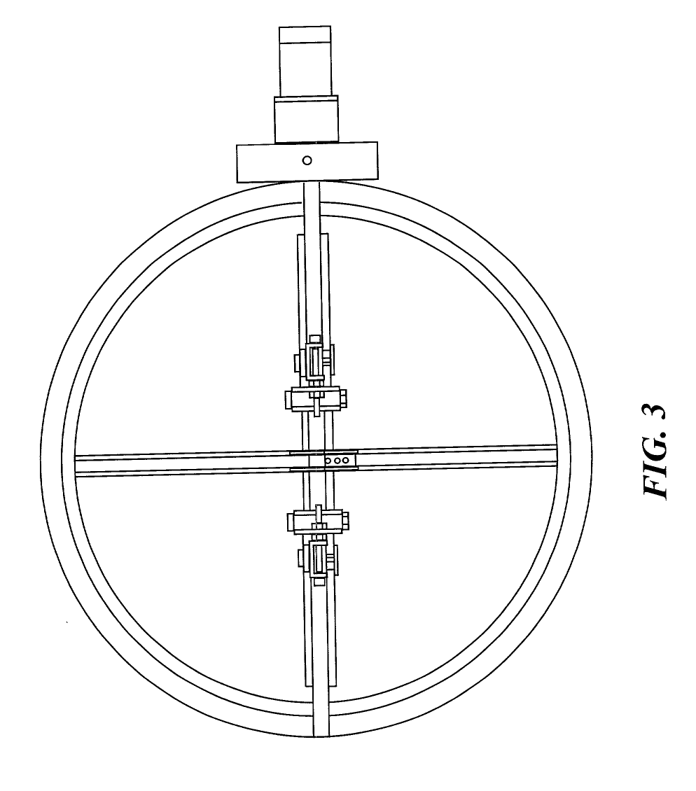

FIG. 4 is a bottom view partially of the damper shown in FIG. 2;

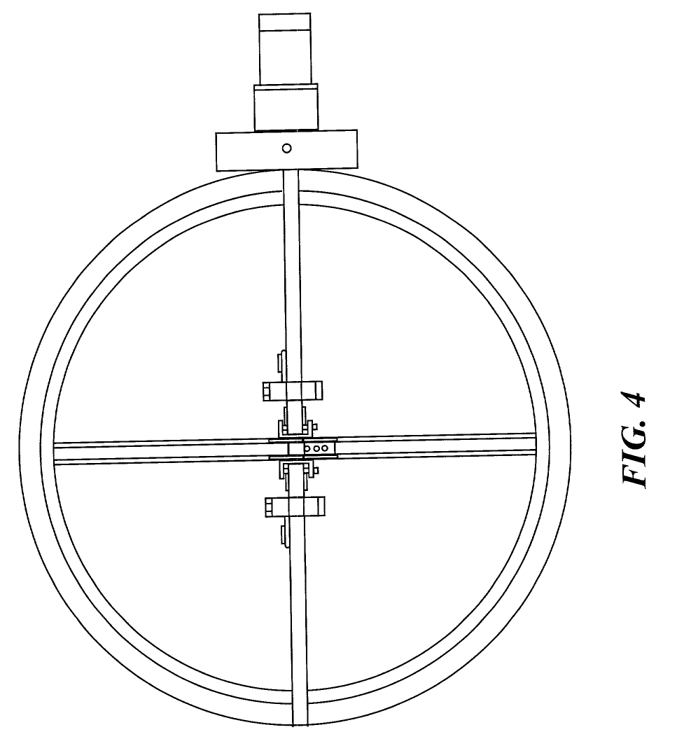

FIG. 5 is an perspective view partially broken away of the damper shown in the prior Figures; only with the blades partially open; and

FIG. 6 is an enlarged, exploded view of a portion of the damper shown in the prior Figures.

### DESCRIPTION OF THE PREFERRED EMBODIMENTS

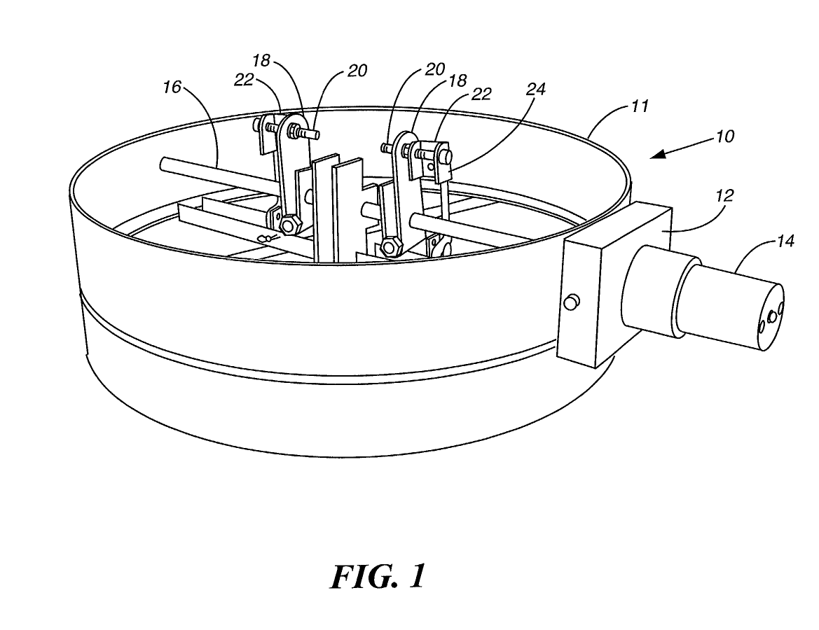

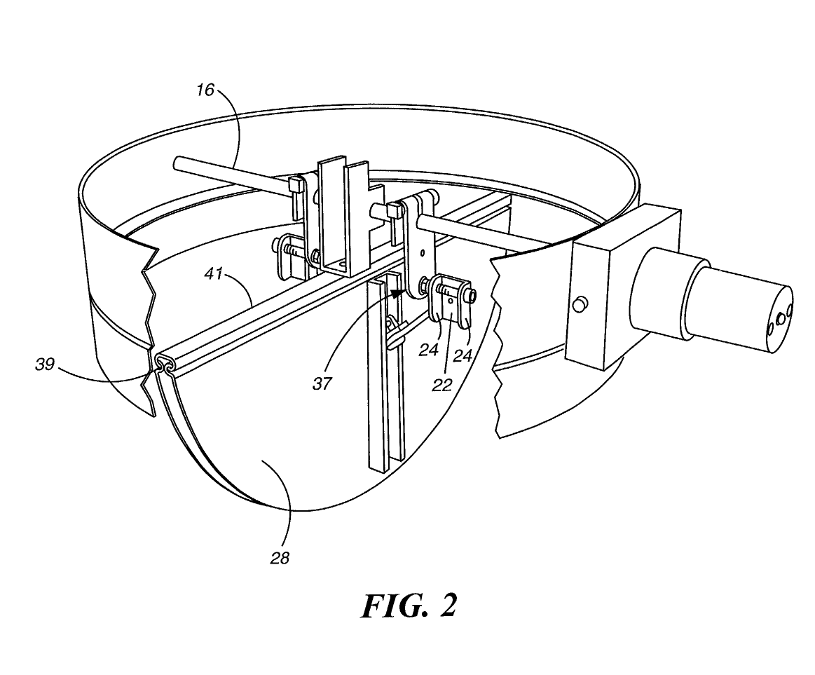

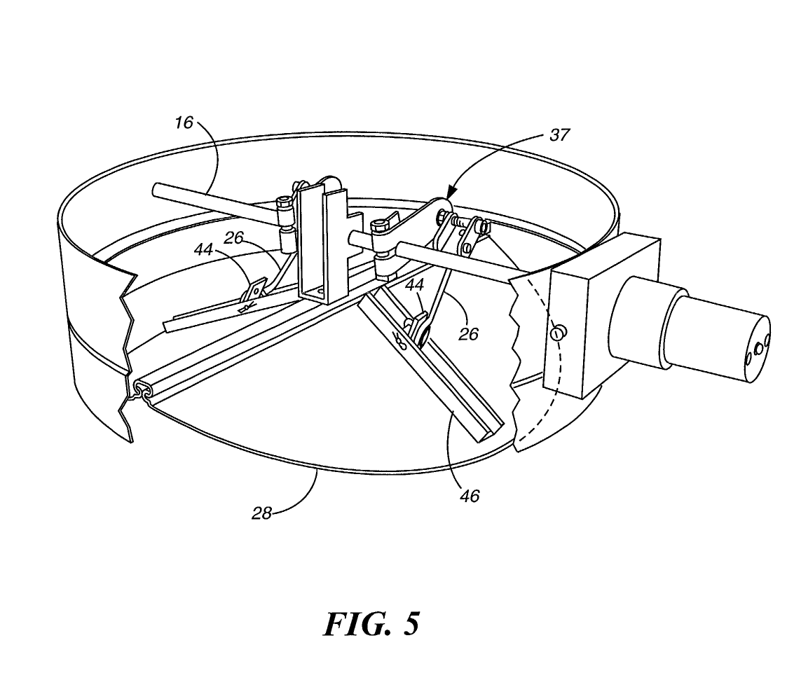

Referring to the drawings, FIG. 1 is a perspective view of a butterfly damper designated generally 10 in the closed position. The damper has attached to its outer frame 11, a motor bracket 12. The bracket 12 has mounted to it a motor 14. The motor is part of an actuator means which includes an extension 16 of the motor shaft. That extension is also part of the operator means for the damper. Fixedly attached to the shaft 16 are crank arms 18 for rotation with the shaft 16. At the distal end of each arm 18 is a bolt 20. The bolts are mounted so that they are axially retained to the distal end of each arm 18. Mounted about each bolt 20 is a bracket 22. Each bracket 22 is U-shaped and is supported by the bolt passing through the arms 24 of the U-shaped structure. The U-shaped bracket 22 is mounted so as to be able to rotate on and with the bolt as will be understood from the following description. As the shaft 16 turns in a clockwise direction when viewed from the motor 14, the crank arms 18 are moved clockwise toward the position as shown in FIG. 5, to open the damper. As the shaft 16 continues to rotate, the damper will ultimately be fully opened as shown in FIG. 2. Normally, the damper would be opening back into the flow of air coming into a room through a duct.

This opening of the damper is accomplished by the operating mechanism which further includes a pair of connector arms 26, FIG. 2, which are mounted for movement with the brackets 22. The other end of each of the connecting arms 26 is pivotally connected to mounting means 44, FIG. 5, pivotally attached to the blade brackets 46 fixedly attached to the blades 28 of the damper.

In the embodiment shown, each of the blades are pivotally mounted along one edge to a connector hinge 39 FIG. 2 fixedly attached to the support structure 41 mounted to the frame 11.

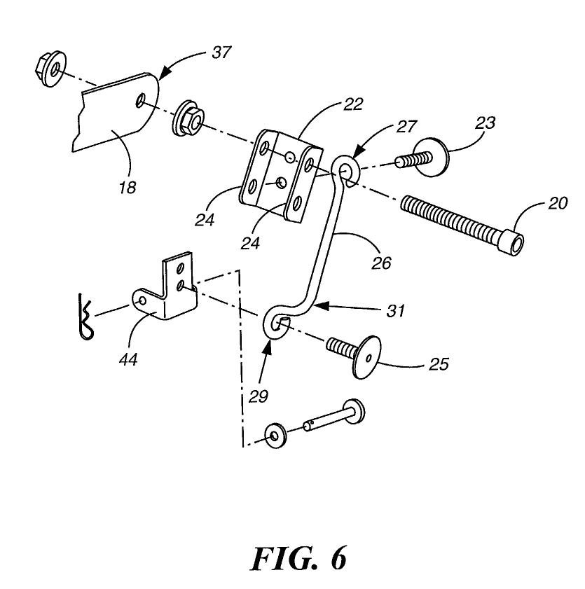

Referring to FIG. 6, the details of the operating mechanism are shown enlarged and exploded for clarity. In particular, the connecting arm is shown in greater detail. One end of the connecting arm 26 is bolted to the bracket 22 through an eye designated generally 27 in a manner such that it can freely rotate about the bolt 23. The other end of the connecting arm 26 is also bolted through an eye designated generally 29 by means of a bolt 25 to an upstanding portion of the mounting means 44. It is also freely rotatable about the bolt 25. This provides for movement as the damper is opened and closed. Because of the bend designated generally 31 in FIG. 6, the device is designed such that at its uppermost and lowermost points, the distal ends designated generally 37 of each crank arm 18 in both the open and the closed positions, are over center of the plane of the center line “CL” of the shaft 16 by preferably 2/10 ths of an inch. This creates what is known as a double acting over center or knee lock. Thus, no matter how much pressure is put upon the blades, they cannot be forced open or closed by external pressure applied to them.

In a fire situation where firemen would be using hoses to force water under high pressure on to the prior art dampers, water could hit the blades of the damper and force them to open. This may not be the optimum condition at the time. An advantage to this device is that in such a situation, the blades will not open in response to the force of the water.

We claim:

1. In a butterfly damper having a plurality of blades movable between an open and a closed position in response to an operating means attached to the blades and attached to an actuating means, the improvement comprising:
said damper operating means having a shaft rotatable about its axis in response to said actuating means; and crank arm means attached to said shaft and said blades, to open and close said damper in response to rotation of said shaft; said crank arm means further comprising crank arms connected to said shaft and connector arm means pivotally connected to said crank arms and pivotally connected to said blades at pivot point locations such that the pivot points of said pivotal connections are over center of the plain of the axis of said shaft when the blades are in the closed position.

2. The damper of claim 1 wherein the pivot point connection locations are such that the pivot points of said pivotal connections are over center of the plain of the axis of said shaft when the blades are in the open position.

3. The damper of claim 1 wherein each crank arm has a distal end remote from the crank arm's connection to said shaft and brackets are mounted to said distal ends; and U-shaped brackets are attached to said distal ends; and the connector arm means are connected to said brackets.
